(19) United States
(12) Patent Application Publication
(10) Pub. No.: US 2013/0265921 A1
(43) Pub. Date: Oct. 10, 2013

(54) METHOD AND SYSTEM FOR SIGNALING BY BIT MANIPULATION IN COMMUNICATION PROTOCOLS

(71) Applicants: Yaron Naim, Herzeliya (IL); Arie Gur, Kiryat Ono (IL)

(72) Inventors: Yaron Naim, Herzeliya (IL); Arie Gur, Kiryat Ono (IL)

(73) Assignee: DSP Group Ltd., Herzliya (IL)

(21) Appl. No.: 13/993,076

(22) PCT Filed: Dec. 13, 2010
(86) PCT No.: PCT/IL2010/001050

§ 371 Date: Jun. 11, 2013

(51) Int. Cl. H04L 12/70

(52) U.S. Cl. CPC H04L 49/602
USPC 370/310

(57) ABSTRACT

In a communication environment configured to transfer data from a transmitting end to a receiving end according to a wireless device communication protocol, said wireless device communication protocol is configured with a field comprising a first content, a method for signaling, comprising: replacing the first content of the field with a second content, the second content is a result of a bit manipulation on said first content of the field; transmitting said second content of the field, by the transmitting end, of the second content of the field is requested and transmitting the first content of the field when signaling of the second content of the field is not required; receiving said second content of the field or first content of the field by the receiver end; and determining if a signaling was performed according to said first content of the field or said second content of the field.

### TECHNICAL FIELD

The present disclosure relates generally to the field of communication protocols and more particularly to a method and system for enabling fast signaling in communication protocols by bit manipulation.

### BACKGROUND

In many communication protocols and communication systems there is a need for enabling fast and reliable signaling, to transfer short messages between the communicating parties, without delay and without deviating from the protocol specification. For example, many new proprietary DECT features need very fast and highly reliable way for signaling between Handset (HS) and base-station (Base).

The DECT support some protocols like Mt esc messages, however those protocols has some limitations: They use A-field which has other data to pass and they have many other information that they need to pass. Thus, they are not fully obligated to one task but support many.

There is a need for a method that enables fast signaling which can be applied on protocol slots which are not dedicated for data transmission and can be used for signaling without reducing their functionality role.

### SUMMARY

An aspect of the disclosed subject matter relates to a method and a system for providing fast and simple signaling in a wireless device communication protocol. The signaling accord to the disclosed subject matter enables to use an existing wireless device communication protocol in a way that the protocol structure is kept unchanged, one or more field may be modified if signaling is required. According to the disclosed subject matter, a first content of a field may be replaced with a second content when signaling is requested. The second content of the field may be chosen from a plurality of bit manipulation options wherein each of the options indicates a different signaling.

It is an object of the present disclosure to provide a method for signaling that is transparent to users when signaling is not performed and enables to keep the usage of an original wireless device communication protocol when signaling is performed.

The present disclosure discloses a method of selectively modifying a content of a field of a wireless device communication protocol when signaling is required, to enable a receiving end to determine that signaling was performed. Modification of field content is carried out by bit manipulation on the content of the field.
In an exemplary embodiment of the disclosed subject matter, in a communication environment configured to transfer data from a transmitting end to a receiving end according to a wireless device communication protocol, said wireless device communication protocol is configured with a field, said field comprises a first content, a method for signaling, the method comprising: replacing the first content of the field with a second content, the second content is a result of a bit manipulation on said first content of the field; transmitting said second content of the field, by the transmitting end, when signaling is required and transmitting the first content of the field when signaling of the second content of the field is not required; receiving said second content of the field or said first content of the field by the receiver end; and determining if a signaling was performed according to said first content of the field or said second content of the field.
In an exemplary embodiment of the disclosed subject matter, the bit manipulation on the first content of the field is applying a bitwise NOT operator on the field F.
In an exemplary embodiment of the disclosed subject matter, the wireless device communication protocol is DECT protocol.
In an exemplary embodiment of the disclosed subject matter, the field is a CRC field.
In an exemplary embodiment of the disclosed subject matter, the field is a SYNC field.
In an exemplary embodiment of the disclosed subject matter, the signaling is used for notifying the receiving end on a Silence Insertion Descriptor (SID)
In an exemplary embodiment of the disclosed subject matter, multiple signaling is applied by choosing the second content from a plurality of bit manipulation options.
In an exemplary embodiment of the disclosed subject matter, there is provided an apparatus configured to transmit data according to a wireless device communication protocol, said wireless device communication protocol is configured with a field that comprises a first content, comprising: a module for selectively replacing the first content of the field with a second content, wherein the second content is a result of a bit manipulation on said first content of the field.
In an exemplary embodiment of the disclosed subject matter, the first content of the field is replaced with a second content responsive to a signal that indicates that signaling is required.
In an exemplary embodiment of the disclosed subject matter, the bit manipulation on said first content of the field is a logic operation on said first content of the field.
In an exemplary embodiment of the disclosed subject matter, the bit manipulation on said first content of the field is performed by hardware or software.
In an exemplary embodiment of the disclosed subject matter, there is provided an apparatus configured to receive data according to a wireless device communication protocol, said wireless device communication protocol is configured with a field that comprises a first content, comprising:
   a module for receiving said field, said module is adapted to compare said received field with said first content and a predefined second content, and determine if a signaling was performed according to said comparison.
In an exemplary embodiment of the disclosed subject matter, the comparison is performed by hardware or software.

### BRIEF DESCRIPTION OF THE DRAWINGS

The present disclosure will be understood and appreciated more fully from the following detailed description taken in conjunction with the drawings. Identical structures, elements or parts, which appear in more than one figure, are generally labeled with a same or similar number in all the figures in which they appear, wherein:

FIG. 1A is a schematic description of a communication environment that applies signaling (prior art);

FIG. 2 is a schematic description of a DECT frame structure (prior art).

FIG. 3A is a schematic diagram that describes signaling by bit manipulation with usage of CRC field in accordance with the disclosed subject matter.

FIG. 3B is a schematic diagram that describes signaling by bit manipulation with usage of SYNC field in accordance with the disclosed subject matter.

FIG. 4 is a flowchart that describes a method of signaling by bit manipulation in accordance with the disclosed subject matter;

### DETAILED DESCRIPTION

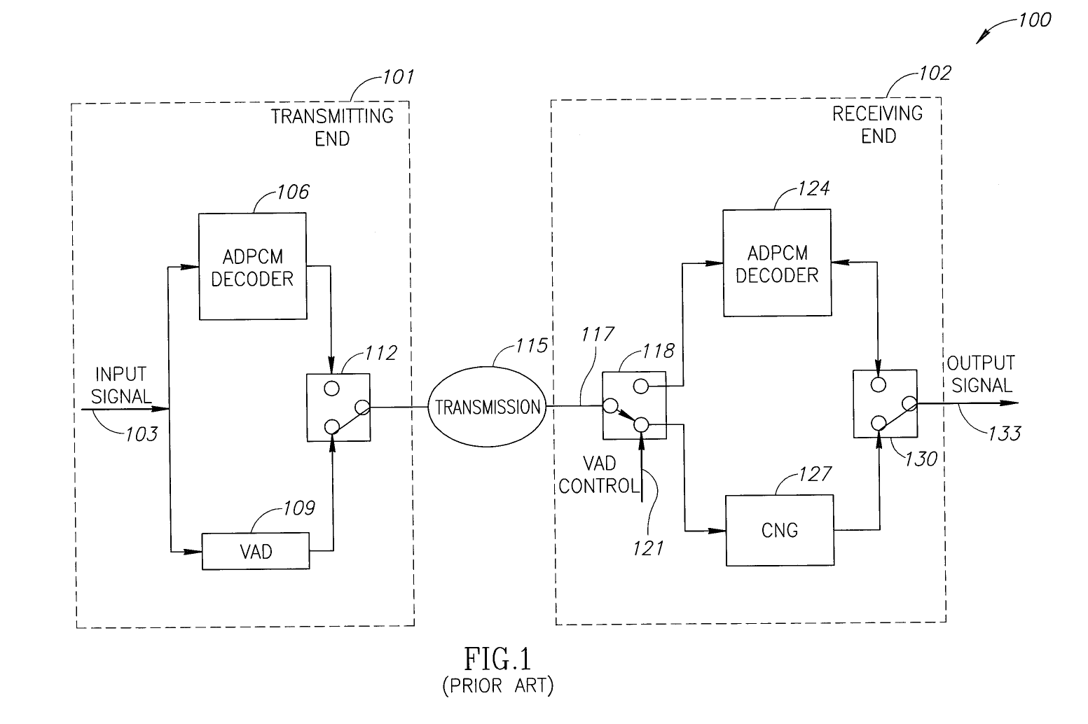

FIG. 1A shows a schematic general block diagram of a communication environment that applies signaling. The communication environment includes a transmitting end 101 and a receiving end 102. The transmitting end transfers data to the receiving end. An input signal 103 is detected by the receiving end where a Voice Activity Detection (VAD) 109 decides whether input signal 103 is a voice/audio frame/packet/slot (or in general—“audio information”) or a silence input. If input signal 103 is found to be audio information, the input signal is encoded by ADPCM encoder 106 and transmitted through transmission switch 112. If input signal 103 is found to be a silence input, VAD 109 controls switch 112 to be closed and no transmission would be sent by the transmitting end 101.

In the receiving end 102, a VAD control 118 defines whether the received signal 117 contains audio information or is just a silence input. If the received signal is found to be audio information it is decoded by ADPCM decoder 124 and output signal 133 is provided by switch 130. If the received signal is found to be silence input, a Comfort Noise Generator (CNG) creates an audio data that produces output signal 133 after being passed by switch 130.

While the theory regarding Comfort Noise Generation is beyond the scope of this disclosure, it will just be noted that in many systems, for the proper functioning of the system, it is important that the transmitting end 101 will be able to provide a fast signaling that will alert the receiving end 102 that the next packet/frame/slot is going to be a silence information. As could be readily understood by a person skilled in the art, the signaling mechanism that should be used in this case must enable an immediate alert for the receiving end 102 and it should be also ensure that the signaling information will fit into the specific protocol that is being used, i.e. there is no specific field in the protocol that supports this signaling, and the protocol should be kept unchanged.

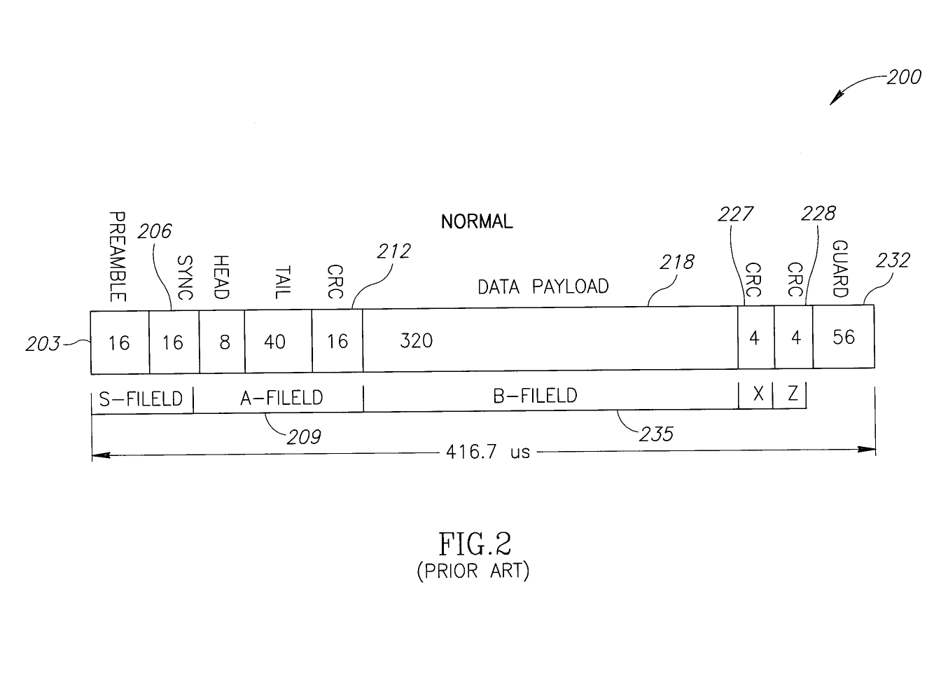

FIG. 2 is a schematic description of a DECT frame structure. While the DECT protocol has various kind of frame structure, FIG. 2 describes a “NORMAL” kind of frame. However, the kind of frame is not part of the present disclosure that is not limited to any specific protocol and may be applied as well to any wireless device communication protocol including wireless phone communication protocol.

Frame 203 which is a normal frame according to the DECT protocol includes some fields as described in FIG. 2. There is a sync field 206; A-field 209; B-field 235, CRC fields 212,227,228. Generally, the data is carried by A-field, therefore it is not possible to use A-field for signaling because the receiving end 102 does not know which data is expected and if the data contained in A-field would be manipulated, there will be no way for the receiving end 102 to conclude it from the received data. However there are fields like CRC and SYNC that contain known, predefined values. These fields are candidates for signaling, as the receiving end 102 knows which values he should expect and if other values are received there eligibility can be verified.

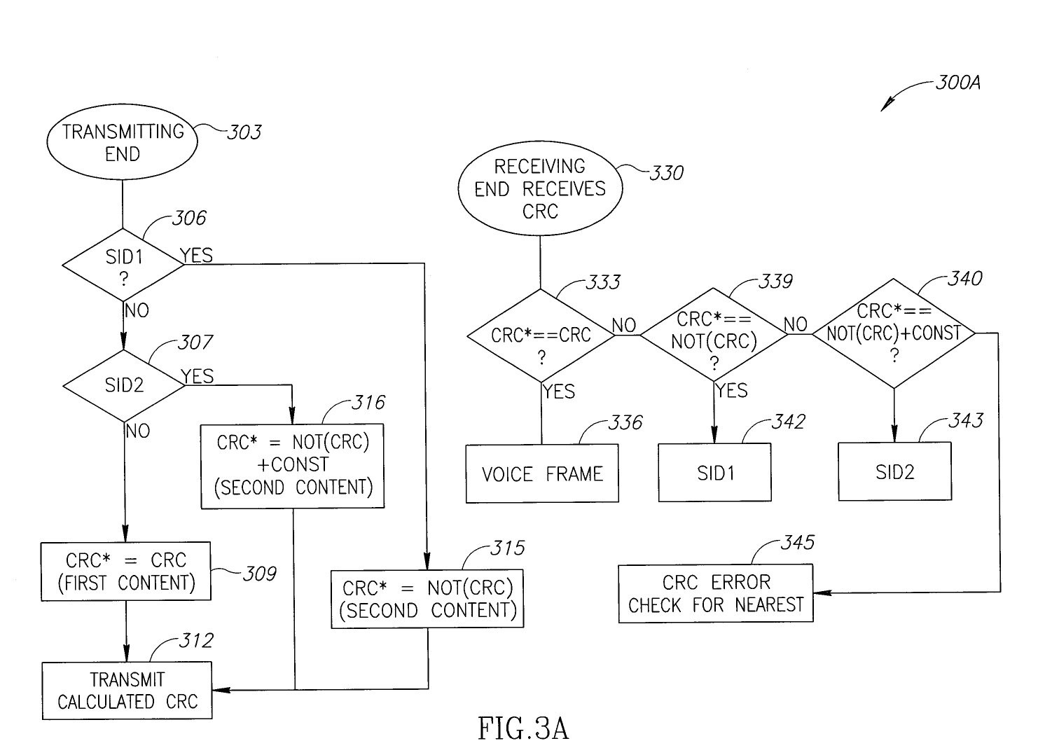

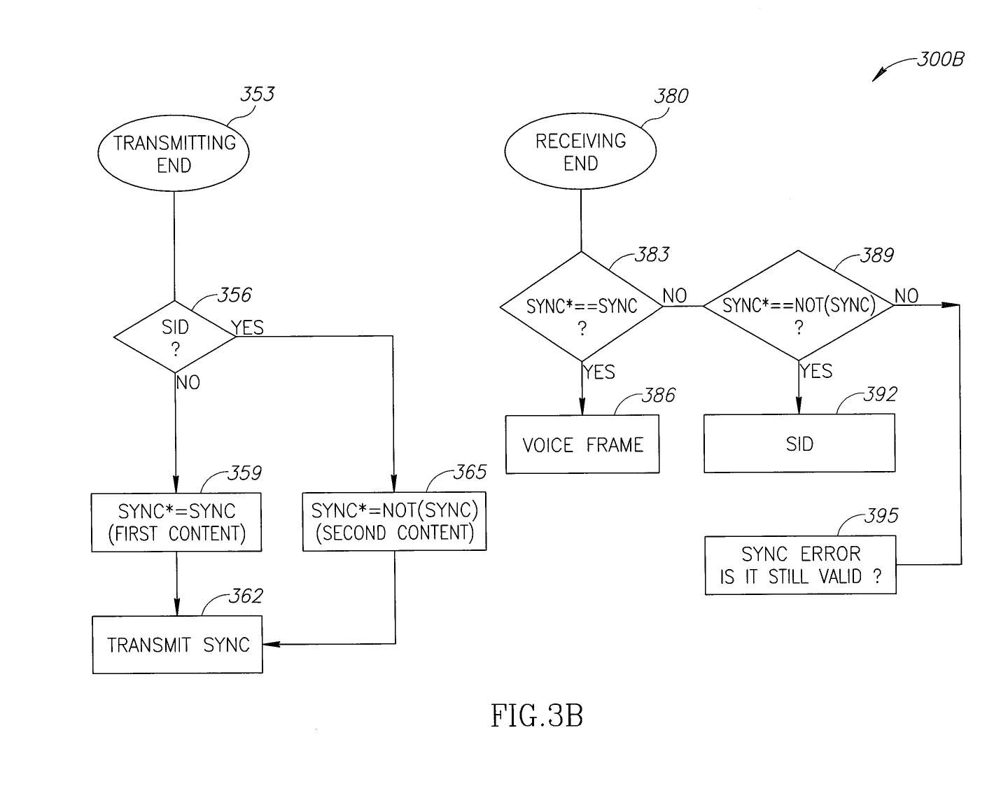

FIG. 3A is a schematic diagram that describes signaling by bit manipulation with usage of CRC field in accordance with the disclosed subject matter. In this example, signaling is used for notifying the receiving end on a Silence Insertion Descriptor (SID). In an exemplary embodiment, transmitting end 303 decides whether the next frame to be transmitted contains audio information or is it going to be a silence frame 306. In case that it is a silence frame, transmitting end 303 needs to send a Silence Insertion Descriptor (SID). In an exemplary embodiment according to the present disclosure, there are two types of SID descriptors named SID1 and SID2, if an SID1 is required, the transmitting end calculates the CRC field content (hereinafter “a first content”) and then performs a bitwise NOT operation on the calculated CRC to result with the transmitted CRC field content marked as CRC* 315 (hereinafter “a second content”). If an SID1 is not needed then system checks if an SID2 is needed 307 and if an SID2 (also “a second content”) is needed than the transmitting end calculates the CRC field content and then performs a bitwise NOT operation on the calculated CRC and then a constant predefined number is added to result with the transmitted CRC field content marked as CRC* (second content) 316=(NOT(CRC)+CONST) It should be noted that using CRC*==NOT(CRC) or (NOT(CRC)+CONST) increases the probability of a CRC error only by factor of 2^{k} where k stands for the number of signals that are used. (In this figure k=2), thus it is still useful and efficient to perform such bit manipulation.

It should be noted that the number of signals that can be used in a given field (hereinafter “multiple signaling” or “the order of signaling”) is limited by a few constraints including the length of the field that limits the number of possible signals, and also the probability of errors and ability to detect and correct errors. However, practically there are cases when the field is relatively long and a high order of signaling is applicable.

If an SID is not needed then CRC field content (first content) remains unchanged 315. Finally the transmitting end 101 transmits CRC field within the transmitted frame 312.

It should be noted that while FIG. 3A describes a specific example where CRC*=NOT(CRC) or (NOT(CRC)+CONST) the present disclosure is not limited to any specific manipulation of the data that is served for signaling. The data may be any kind of data (not limited to be a “field” as it is defined in the DECT protocol) in any kind of communication protocol. The bit manipulation may be any kind of logic operator or a combination of logic operators, the second content can be chosen from a plurality of bit manipulation, the manipulation may be calculated by H/W, S/W, F/W or any method this is known for replacing k bits of data with other k bits of data. While one-one manipulation functions are preferred it is not always a must. As can be readily understood by a person skilled in the art, there is an advantage for the choice of functions that can be easily calculated by a simple H/W. For example the usage of bitwise NOT operator requires only one NOT gate (both in the transmitting end 101 and at the receiving end 102) and provides a fast cheap and simple solution. It should further be noted that the bit manipulation is not limited to a single modification, thus the signaling may enable one or more types of signaling corresponding to a plurality of modifications. Obviously increasing the number of modifications results with increasing the probability of a CRC error.

FIG. 3A further shows the receiving end receiving a CRC field 330, the receiving end first compares the received CRC* field content to the expected CRC 333 and if they equal then the receiving end determines that the coming frame is a voice frame (no signaling was used). If the received CRC* field content does not equal the expected CRC then the receiving end compares the received CRC* field content to NOT(CRC) 339, if they equal then the receiving end determines that the coming frame is a silence frame 342 of type 1 (SID1), signaling was performed. (Referring to FIG. 1, the CNG 127 will produce Comfort Noise (CN) to prevent a silence frame from being played to a listener, as real silence should be avoided in these systems). If the received CRC* field content does not match NOT(CRC) then it is compared to ((Not(CRC)+CONST) 340, if they equal then the receiving end determines that the coming frame is a silence frame 343 of type 2 (SID2)-signaling was performed. than there is an error in the received CRC* field content 345. In this case the receiving end may check if the received CRC* field content is close enough to either CRC or NOT(CRC) or ((Not(CRC)+CONST) and if an error correction is possible. However these decisions are beyond the scope of the present disclosure, as they are not specific to signaling and may required also when signaling is not applied at all.

The method that is described in FIG. 3A regarding the transmitting end 303 can be easily implemented by a common transmitter that includes a module for selectively replacing the first content of the field with a second content, wherein the second content is a result of a bit manipulation on said first content of the field. Such module may be implemented by hardware or software. The module replaces the first content of the field with a second content responsive to a signal that indicates that signaling is required. The bit manipulation may be a logic operation or any other for of bit manipulation on the first content of the field.

The same applies for the receiving end 330 that may be implemented by a module for receiving the transmitted field, the module is adapted to compare the received field with the first content and a predefined second content, and determine if a signaling was performed according to said comparison. The comparison may be performed by hardware or software.

FIG. 3B is a schematic diagram that describes signaling by bit manipulation with usage of SYNC field in accordance with the disclosed subject matter.

Generally the same flow that was applied for signaling by usage of CRC is applicable for signaling by usage of a SYNC filed. Therefore FIG. 3B is has the same structure as FIG. 3A with a few minor changes, as the manipulated field is different, FIG. 3B also describes a case where the manipulated field may be modified to only a single signaling case (the order of signaling is one).

However a SYNC field has two basic differences from CRC field. A SYNC field is usually a predefined field that does not changes and thus does not depend on the data. Furthermore, the SYNC field must have a special characteristic as it must show good error immunity to itself, i.e. since the SYNC is received from a wireless transmission it may be shifted by one bit (one clock cycle), in this case it is required that both the original SYNC field content (first content) (e.g. 0xE98A) and the inverted SYNC field content (second content) (0x1675) will have good immunity to their selves. When using SYNC field for signaling there is also the probability for replacing them in the receiver end 102, however this probability is still very low

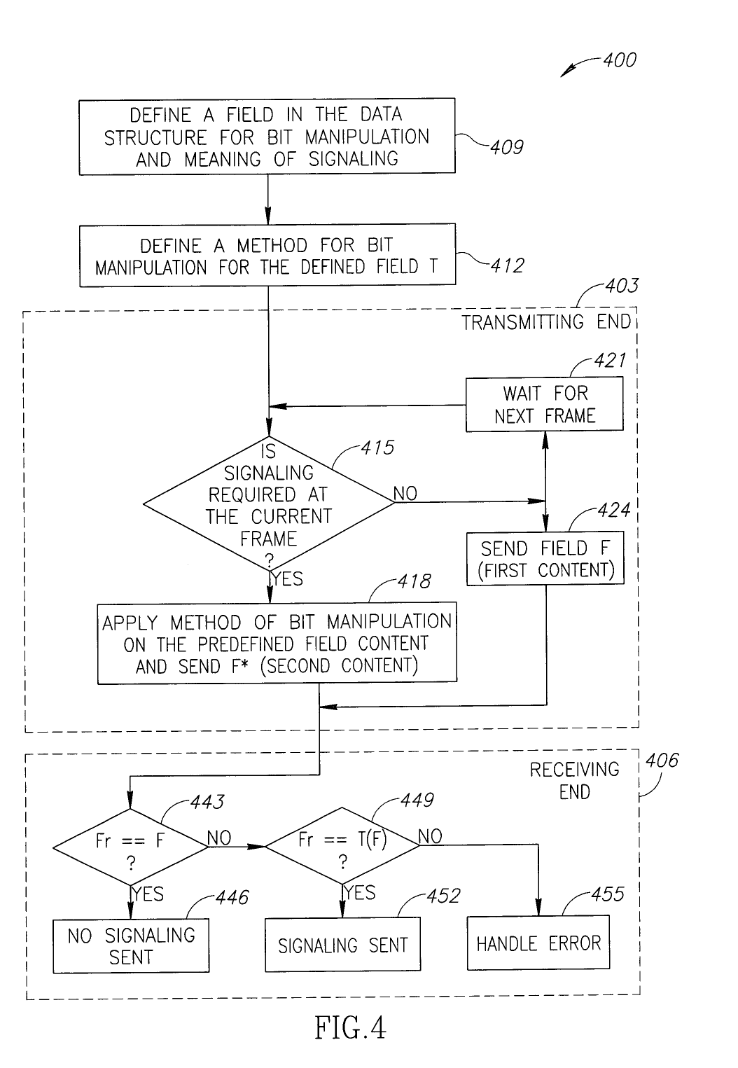

FIG. 4 is a flowchart that describes a method of signaling by bit manipulation in accordance with the disclosed subject matter.

In an exemplary embodiment in accordance with the present disclosure, a field for signaling is defined in the data structure to support the signaling 409, (obviously also the meaning of the signaling must be agreed between the communicating parties). It should be noted that the term “field” does not necessarily refers to the term field as used in the DECT protocol or in any other protocol but is rather a general name for a sub group of the data structure that is used in a certain protocol. After defining the field for signaling, a method T for bit/field manipulation is defined 412. As mentioned before this method may be as simple as applying a bitwise NOT on the original field content but may be any other algebraic manipulation as long as the result is equal in its length to the original field.

While the above steps should take place before any communication starts, when communication begins, the transmitting end 101 should define if signaling is required in the current frame 415. If signaling is required than the field that is used for signaling is manipulated (second content) and sent 418. If signaling is not required than the field content that is used for signaling is kept unchanged (first content) and sent 424.

In the receiving end the received field content Fr is compared to the expected field F 443 and if they match than receiving end 102 determines that a signaling was not used 446.

If Fr !=F than the receiver end checks if the received field Fr equals to T(F) 449 and if it does than the receiving end determines that signaling 452 took place. If both comparisons failed than the receiving end has an indication of an error which should be handled according to the specific case. (This part is beyond the scope of the present disclosure). It should be noted that while FIG. 4 shows a sequential flow where Fr is compared to F and only later if the check fails Fr is compared to T(F), there is no bar from doing both comparisons simultaneously.

It should be appreciated that the above described methods and systems may be varied in many ways, including omitting or adding steps, changing the order of steps and the type of devices used. It should be appreciated that different features may be combined in different ways. In particular, not all the features shown above in a particular embodiment are necessary in every embodiment of the disclosed subject matter. Further combinations of the above features are also considered to be within the scope of some embodiments of the disclosed subject matter.

Section headings are provided for assistance in navigation and should not be considered as necessarily limiting the contents of the section.

It will be appreciated by persons skilled in the art that the present disclosure is not limited to what has been particularly shown and described hereinabove. Rather the scope of the present disclosure is defined only by the claims, which follow.

1. In a communication environment configured to transfer data from a transmitting end to a receiving end according to a wireless device communication protocol, said wireless device communication protocol is configured with a field, said field comprises a first content, a method for signaling, the method comprising:
(a) replacing the first content of the field with a second content, the second content is a result of a bit manipulation on said first content of the field;
(b) transmitting said second content of the field, by the transmitting end, when signaling is required and transmitting the first content of the field when signaling of the second content of the field is not required;
(c) receiving said second content of the field or said first content of the field by the receiver end; and
(d) determining if a signaling was performed according to said first content of the field or said second content of the field; and
wherein the wireless device communication protocol is the DECT protocol.

2. The method of claim 1, wherein the bit manipulation on the first content of the field is applying a bitwise NOT operator on the field F.

3. (canceled)

4. The method of claim 1, wherein the field is a CRC field.

5. The method of claim 1, wherein the field is a SYNC field.

6. The method of claim 1, wherein the signaling is used for notifying the receiving end on a Silence Insertion Descriptor (SID).

7. The method of claim 1, wherein multiple signaling is applied by choosing the second content from a plurality of bit manipulation options.

8. An apparatus configured to transmit data according to a wireless device communication protocol, said wireless device communication protocol is configured with a field that comprises a first content, comprising:
a module for selectively replacing the first content of the field with a second content, wherein the second content is a result of a bit manipulation on said first content of the field; and
wherein the wireless device communication protocol is the DECT protocol.

9. The apparatus according to claim 8, wherein the first content of the field is replaced with a second content responsive to a signal that indicates that signaling is required.

10. The apparatus according to claim 9, wherein the bit manipulation on said first content of the field is a logic operation on said first content of the field.

11. The apparatus according to claim 9, wherein the bit manipulation on said first content of the field is performed by hardware or software.

12. An apparatus configured to receive data according to a wireless device communication protocol, said wireless device communication protocol is configured with a field that comprises a first content, comprising:
a module for receiving said field, said module is adapted to compare said received field with said first content and a predefined second content, and determine if a signaling was performed according to said comparison; and
wherein the wireless device communication protocol is the DECT protocol.

13. The apparatus according to claim 12, wherein the comparison is performed by hardware or software.
